(19) United States
(12) Patent Application Publication
(10) Pub. No.: US 2007/0091020 A1
(43) Pub. Date: Apr. 26, 2007

(54) Plasma display apparatus

(76) Inventors: Ki Rack Park, Chilgok-gun (JP); Doo Yong Hwang, Yongin-si (KR)

Correspondence Address: FLESHNER & KIM, LLP, P.O. BOX 221200, CHANTILLY, VA, 20153, US

(21) Appl. No.: 11/582,560

(22) Filed: Oct. 18, 2006

(30) Foreign Application Priority Data
Oct. 21, 2005 (KR) 10-2005-0099773

(51) Int. Cl. G09G 3/28

(52) U.S. Cl. 345/63

(57) ABSTRACT

The present invention relates to a plasma display apparatus having different widths of data signals applied to an address electrode in the address period. Particularly, data signals are set to have different rising time, sustain time, and falling time such that the picture quality reduction and the driving efficiency degradation due to a misdischarge in the address period can be improved, and the circuit damage by the peak current can be prevented.

This application claims the benefit of Korean Patent Application No. 10-2005-0099773 filed on Oct. 21, 2005, which is hereby incorporated by reference for all purposes as if fully set forth herein.

### BACKGROUND OF THE INVENTION

1. Field of the Invention

The present invention relates to a plasma display apparatus and, more particularly, to a plasma display apparatus which makes the width of at least two data signals different among a plurality of data signal in order to prevent a misdischarge which is generated during address discharge between a scan electrode and an address electrode in an address period.

2. Description of the Conventional Art

A conventional plasma display panel is an apparatus which generates a discharge by applying a predetermined voltage to electrodes arranged in the discharge space and displays an image including a character and a graphic when plasma which is generated in the gaseous discharge time excites a phosphor.

A large-size, a light weight and a plane thin shaping are facilitated by the apparatus. The apparatus provides a wide viewing angle in all directions, has an advantage in that it is capable of implementing a full-color and a high brightness.

To implement gray levels of an image, the plasma display panel is driven with one frame which is time-divided into a plurality of subfields having different light emitting number of times. Further, each subfields are divided into a reset period for initializing the entire screen, an address period for selecting a scan line and selecting a discharge cell in the selected scan line, and a sustain period for implementing a gray scale according to the number of times of discharge.

In the address period, a scan signal is sequentially applied to a scan electrode and, simultaneously, a data signal of positive polarity is applied to an address electrode to generate an address discharge.

However, conventionally, there is a problem that the variation of electric potential is drastically made in the rising period and the falling period of data signal so that the drive unit is damaged, and a misdischarge is generated in the address discharge time.

### SUMMARY OF THE INVENTION

Accordingly, the present invention has been made in view of the above problems occurring in the prior art, and it is an object of the present invention to provide a plasma display apparatus which is driven by time dividing an unit frame into a plurality of subfields to display an image, wherein at least two data signals among a plurality of data signals have different widths in one subfield of a plurality of subfields.

The data signal includes a rising time, a sustain time, and a falling time, while the sum of the rising time, the sustain time, and the falling time form the width of the data signal, wherein the rising time and the falling time respectively ranges from 50 ns to 300 ns.

The falling time of the data signal is longer than the rising time.

The sustain time of the data signal ranges from 1 us to 5 us.

The sustain time of the data signal ranges from 1 us to 3 us.

In one subfield of the plurality of subfields, a scan signal which is applied to a plurality of scan electrodes is comprised of a falling time, a sustain time, and a rising time, wherein the rising time of the scan signal is different from the falling time of the data signal corresponding to the scan signal.

In one subfield of the plurality of subfields, the rising time of a first data signal is different from the rising time of a second data signal while the application time point of the second data signal is late than the application time point of the first data signal.

In one subfield of the plurality of subfields, the sustain time of a first data signal is different from the sustain time of a second data signal while the application time point of the second data signal is late than the application time point of the first data signal.

In one subfield of the plurality of subfields, the falling time of a first data signal is different from the falling time of a second data signal while the application time point of the second data signal is late than the application time point of the first data signal.

In one subfield of the plurality of subfields, the start time point of a scan signal is different from the start time point of a data signal corresponding to the scan signal.

The difference between the point of time when the scan signal is applied and the point of time when the data signal is applied ranges from 10 ns to 300 ns.

In one subfield of the plurality of subfields, the end-point of a scan signal is different from the end-point of a data signal corresponding to the scan signal.

The difference between the end-point of the scan signal and the end-point of the data signal ranges 10 ns or 200 ns.

### BRIEF DESCRIPTION OF THE DRAWINGS

The invention will be described in detail with reference to the following drawings in which like numerals refer to like elements. The accompany drawings, which are included to provide a further understanding of the invention and are incorporated in and constitute a part of this specification, illustrate embodiments of the invention and together with the description serve to explain the principles of the invention. In the drawings:

FIG. 1 is a drawing which shows an embodiment of a panel structure of a plasma display apparatus.

FIG. 2 is a drawing which shows an embodiment of the method in which one frame of an image of a plasma display apparatus is time-divided into a plurality of subfields for driving.

FIG. 3 is a drawing which shows an embodiment of the electrode arrangement of a plasma display panel.

FIG. 4 is a drawing which shows an embodiment of driving signals for driving a plasma display panel.

FIG. 5 is a drawing which shows data signals of a plasma display apparatus according to the present invention.

FIG. 6a to FIG. 6h show embodiments of driving signals of a plasma display apparatus according to the present invention.

FIG. 7a to FIG. 8 show embodiments of the relationship of a scan signal and a data signal of a plasma display apparatus according to the present invention.

FIG. 9a to FIG. 10c show embodiments of data signals in arbitrary subfields among a plurality of subfields.

### DETAILED DESCRIPTION OF THE PREFERRED EMBODIMENT

Preferred embodiments of the present invention will be described in a more detailed manner with reference to the drawings.

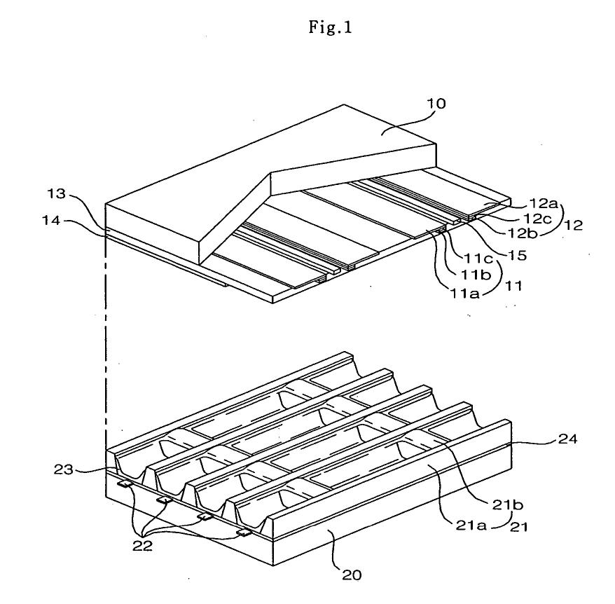

Hereinafter, the embodiments of the present invention will be illustrated in detail with reference to FIG. 1 to FIG. 10.

FIG. 1 is a drawing for illustrating the panel structure of the present invention. A front substrate 10 and a rear substrate 20 are coalesced to form a panel.

A scan electrode 11 and a sustain electrode 12 which are a sustain electrode pair are formed on the front substrate 10. An address electrode 22 is formed in the direction intersecting with the scan electrode 11 and the sustain electrode 12.

Generally, the sustain electrode pair 11, 12 respectively include a transparent electrode 11a, 12a and a bus electrode 11b, 11b made of Indium-Tin-Oxide ITO. Bus electrode 11b, 12b can be made of metal including silver Ag, chrome Cr, of a stack of chrome /copper/chrome Cr/Cu/Cr, or of a stack of chrome/aluminium/chrome Cr/Al/Cr.

Moreover, the bus electrode 11b, 12b is formed on the transparent electrode 11a, 12a to reduce the voltage drop by the transparent electrode 11a, 12a which have a high resistance.

Moreover, in a plasma display panel, a black matrix that performs the function of an optical cut-off which reduces a reflection by absorbing the external light generated in the outside of the front substrate 10 and the function of improving the purity and the contrast of the plasma display panel is formed.

Such black matrix is comprised of a first black matrix 15 which is formed in the position overlapped with a barrier rib 21 which is formed in the rear substrate 10 and a second black matrix 11c, 12c which is formed between a transparent electrode 11a, 12a and a bus electrode 11b, 12b. In this way, the black matrix which is separately formed into the first black matrix 15 and the second black matrix 11c, 12c can be termed the separable black matrix. The second black matrix 11c, 12c can be termed the black layer or the black electrode layer since they form layers between electrodes.

In the meantime, like the embodiment of the present invention, the sustain electrode pair 11, 12 can be formed not only with the structure in which the transparent electrode 11a, 12a and the bus electrode 11b, 12b are laminated but just only with the bus electrode 11b, 12b without the transparent electrode 11a, 12a.

Since the structure does not use the transparent electrode 11a, 12a, it has the advantage of reducing the cost of the panel manufacture.

In addition to the material described above, a various material including a photoresist material can be used for the bus electrode 11b, 12b.

In the front substrate 10 where the scan electrode 11 and the sustain electrode 12 are formed, an upper dielectric layer 13 and a protective layer 14 are laminated. In the uppper dielectric layer 13, charged particles generated by a discharge are accumulated and the function of protecting the sustain electrode pair 11, 12 can be performed.

The protective layer 14 protects the upper dielectric layer 13 from the sputtering of the charged particles generated in the gaseous discharge time, enhancing the emission efficiency of the secondary electron.

Moreover, as to the protective layer 14, the magnesium oxide MgO is generally used, but the Si—MgO in which the silicon Si is added can be used. At this time, the content of the silicon Si which is added to the protective layer 14 can range from 50 PPM to 200 PPM in a weight percent wt % base.

Moreover, in the rear substrate 20 in which the address electrode 22 is formed, a lower dielectric layer 24 and the barrier rib 21 are formed. A phosphor 23 in which the visible light is generated by the light-emitting of the ultraviolet ray which is generated in the gaseous discharge time is coated onto the surface of the lower dielectric layer 24 and the barrier rib 21.

The barrier rib 21 is comprised of a column barrier rib 21a formed with the address electrode 22 side by side, a row barrier rib 21b formed in the direction intersecting with the column barrier rib 21a. The barrier rib 21 physically partitions the discharge cell, preventing the ultraviolet ray and the visible light which are generated by a discharge from being leaked out to the adjacent discharge cell.

The structure of the panel shown in FIG. 1 is just an embodiment of the structure of a plasma display panel according to the present invention, therefore, the present invention is not restricted in the structure of the plasma display panel shown in FIG. 1. For example, the sustain electrode pair 11, 12 can include 2 or more electrode lines respectively, moreover, can include other electrodes.

Further, the barrier rib structure of the plasma display panel shown in FIG. 1 shows the close type in which the discharge cell has a closed architecture with the column barrier rib 21a and a row barrier rib 21b. However, it is not restricted in such type.

A differential type barrier rib structure where the height of the column barrier rib 21a and the row barrier rib 21b are different, a channel type barrier rib structure where a channel which can be used as ventilating passage is formed in at least one of the column barrier rib 21a and the row barrier rib 21b, and a hollow type barrier rib structure where a hollow is formed in at least one of the column barrier rib 21a and the row barrier rib 21b can be used.

In addition, a fish bone structure where a protrusion is formed with a predetermined gap on the column barrier rib 21a can be used.

Here, in the differential barrier rib structure, it is preferable that the height of the row barrier rib 21b is higher than the height of the column barrier rib 21a. In the channel type barrier rib structure or the hollow type barrier rib structure, it is preferable that a channel or a hollow is formed in the row barrier rib 21b.

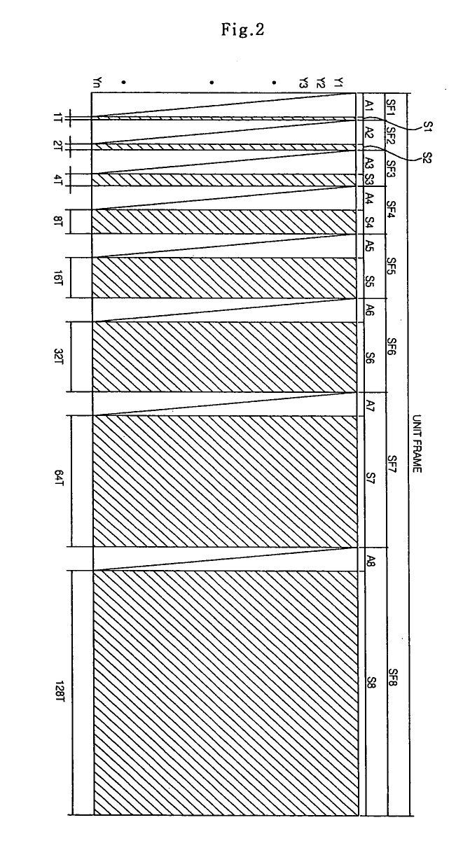

FIG. 2 is a drawing which shows an embodiment of the method in which one frame of an image is time-divided into a plurality of subfields for driving.

Referring to FIG. 2, a unit frame can be time-divided into a predetermined number, for example, 8 subfield SF1, . . . , SF8 for driving in order to display the gray scale of an image. Moreover, each subfield SF1, . . . , SF8 is divided into a reset period(not shown), an address period A1, . . . , A8, and a sustain period S1, . . . , S8.

In each address period A1, . . . , A8, a data signal is applied to the address electrode X, while a corresponding scan signal is sequentially applied to each scan electrode Y. In each sustain period S1, . . . , S8, a sustain signal is alternately applied to the scan electrode Y and the sustain electrode Z so that a sustain discharge is generated in discharge cells selected in the address period A1, . . . , A8.

Here, the reset period can be omitted in at least one subfield among a plurality of subfields. For example, the reset period can exist only in the first subfield, or can exist only in the intermediate subfield among the first subfield and the total subfields.

The luminance of the plasma display panel is in proportion to the sustain discharge frequency of the sustain period S1, S8 in the unit frame. When one frame forming one image is expressed with 8 subfields and 256 gray scales, the different number of the sustain signal can be allocated to each subfield at the rate of 1, 2, 4, 8, 16, 32, 128. To obtain the luminance of 133 gray scale, a cell addressing is performed in subfield one period, subfield three period and subfield eight period for a sustain discharge.

In the meantime, the sustain discharge frequency allocated to each subfield can be variably determined according to the weight of the subfields due to an Automatic Power Control APC step. That is, in FIG. 2, it was exemplified that a frame is divided into 8 subfields.

However, the present invention is not restricted in such a case. The number of subfield forming a frame can be variously changed according to the design type. For example, a frame can be divided into below or over 8 subfields like 12 subfield or 16 for driving a plasma display panel.

Moreover, it is possible that the sustain discharge number allocated to each subfield can be variously changed in consideration of the gamma characteristics or the panel characteristics. For example, the gray level allocated to subfield 4 can be lowered from 8 to 6, while the gray level allocated to subfield 6 can be enhanced from 32 to 34.

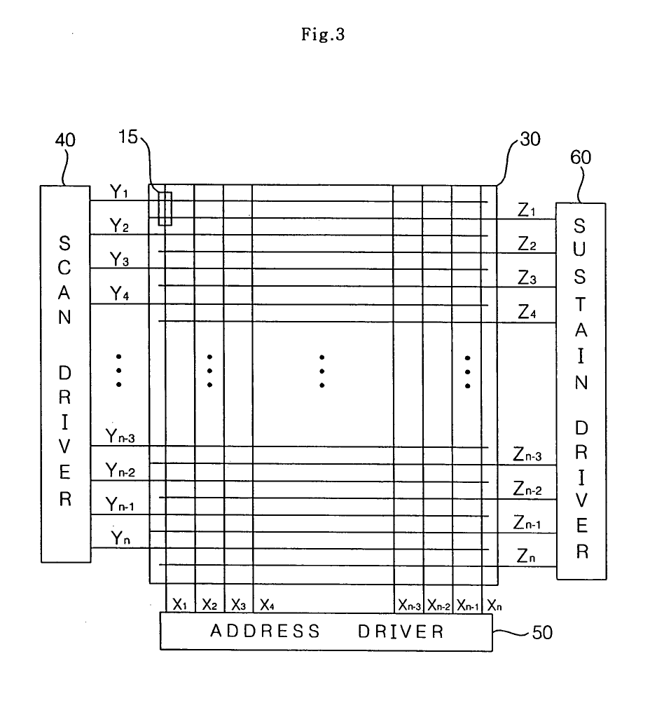

FIG. 3 is a drawing which shows an embodiment of the electrode arrangement of a plasma display panel.

Referring to FIG. 3, a plurality of discharge cells 15 are provided in the intersection of scan electrodes Y1 to Yn, sustain electrodes Z1 to Zn, and address electrodes X1 to Xn. A plurality of scan electrodes Y1 to Yn are sequentially drived by a scan driver 40.

A plurality of sustain electrodes Z1 to Zn receives a sustain signal supplied from a sustain driver 60 for driving in common. Additionally, a plurality of address electrodes X1 to Xn receive a data signal synchronized with the scan signal from an address driver 50.

In the meantime, the electrode arrangement and the driving method shown in FIG. 3 is just an embodiment of a plasma display panel according to the present invention, therefore, the present invention is not restricted in the electrode arrangement and the driving method shown in FIG. 3.

For example, the dual scan mode in which two scan electrodes among scan electrodes Y1 to Yn are simultaneously scanned can be used. Moreover, the address electrodes X1 to Xn can be divided into the odd number address electrodes X1, X3, . . . , Xn-1 and the even number address electrodes X2, X4, Xn, with the odd number address driver and the even number address driver to receive the driving signal respectively.

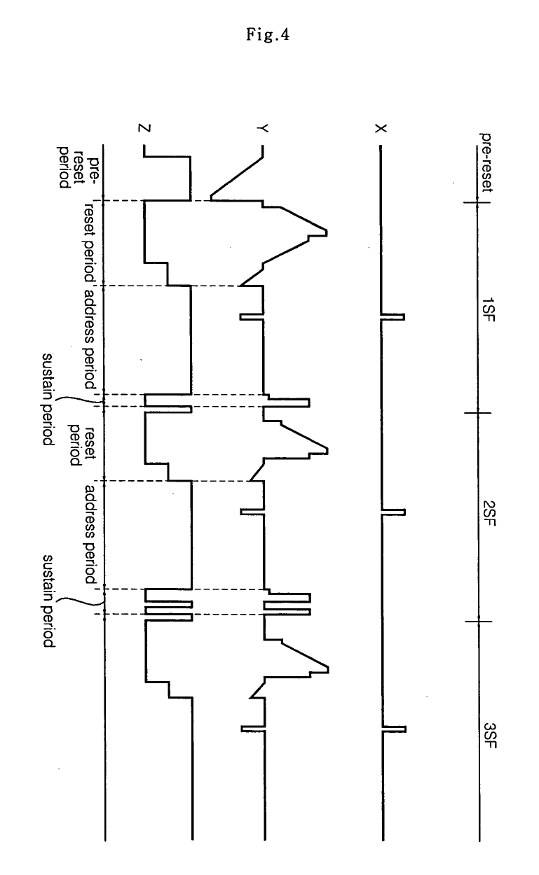

FIG. 4 is a drawing which shows an embodiment of driving signals for driving a plasma display panel.

Referring to FIG. 4, each subfield SF is divided into a reset periode initializing the electric charge in the discharge cell, an address period selecting a discharge cell in which an image is displayed or selecting a discharge cell in which an image is not displayed, and a sustain period in which an image is displayed by generating a sustain discharge in the discharge cell where the selected image is displayed in the address period.

The reset period is divided again into a set up period and a set down period. In the set up period, the set up signal which gradually rises is applied to the scan electrode Y to generate a set up discharge in all discharge cells so that the wall charges are accumulated. In the set down period, the set down signal which gradually or abruptly falls is applied to the scan electrode Y to generate a weak erasing discharge.

Moreover, a prereset period exists before the reset period to support a sufficient formation of the wall charge. When the signal in which the voltage value of the scan electrode Y is gradually reduced before the reset period, the prereset discharge is generated by applying the voltage of the positive polarity to the sustain electrode Z. It is preferable that the prereset period exists in the first subfield SF1 in consideration of the drive margin.

In the address period, the scan signal is sequentially applied to each scan electrode Y, simultaneously, the data signal of positive polarity synchronized with the scan signal applied to the scan electrode Y is applied to the address electrode X.

Due to the voltage difference of scan signal and data signal and the wall charges generated in the reset period, the address discharge is generated in the discharge cell to form a sustain discharge.

In the sustain period, the sustain signal is alternately applied to the scan electrode Y and the sustain electrode Z. Whenever each sustain signal is applied, the sustain discharge, that is, the display discharge is occurred in the discharge cell selected by the address discharge.

In the meantime, as the waveform shown in FIG. 4 is an embodiment of signals for driving a plasma display panel according to the present invention, the present invention is not restricted by waveforms shown in the above FIG. 4.

For example, the reset period can be omitted in at least one subfield among a plurality of subfields comprising one frame, while the reset period can be exist in the first subfield. Moreover, the prereset period can be omitted and, if necessary, the polarity of the driving signal and the voltage level shown in FIG. 4 can be changed.

Moreover, the erase signal for the wall charge erase can be applied to the sustain electrode Z after the sustain discharge is completed. The sustain signal can be applied to only one of the scan electrode Y and the sustain electrode Z to perform a single sustain drive causing a sustain discharge.

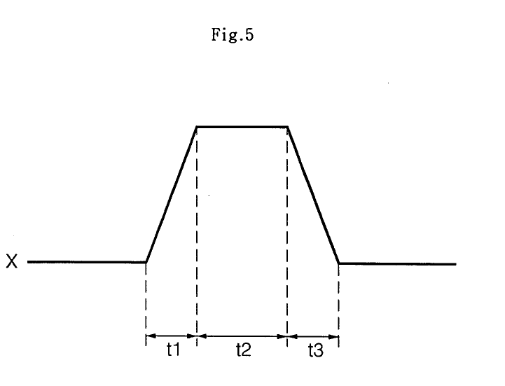

Moreover, among data signals applied to the address electrode X in the address period, the width of at least two data signals can be different. The related description will be illustrated with reference to embodiments shown in FIG. 5 to FIG. 10.

Referring to FIG. 5, the data signal applied to the address electrode X in the address period is shown. The data signal includes a rising time T1 rising to a predetermined data voltage, a sustain period T2 sustaining a voltage and a falling period T3.

At this time, the width of data signal is defined as the sum of rising time T1, sustain period T2, and falling period T3, or T1+T2+T3.

The rising time T1 of data signal is a period where the address discharge is substantially occurred, and it is preferable that the rising time T1 ranges from 50 ns to 300 ns.

In this case, the data signal can be sufficiently supplied to the address electrode in the limited address period, and a misdischarge due to a sudden voltage variations can be prevented.

Further, it is preferable that the falling time T3 of data signal ranges from 50 ns to 300 ns. In this case, the peak value of the displacement current is reduced due to the voltage which gradually falls.

Accordingly the circuit damage can be prevented. Here, it is preferable that the falling time T3 of data signal is longer than the rising time T1 in order to improve the luminance characteristic of a screen by preventing the unnecessary discharge of a cell.

Further, it is preferable that the sustain period T2 of data signal ranges from 1 us to 5 us, more preferably, ranges from 1.5 us to 3 us so that the discharge time is sufficiently sustained to smoothly select the cell which is scanned.

Accordingly, in a subfield among a plurality of subfields, the width of at least two data signals applied to the address electrode in the address period can be different.

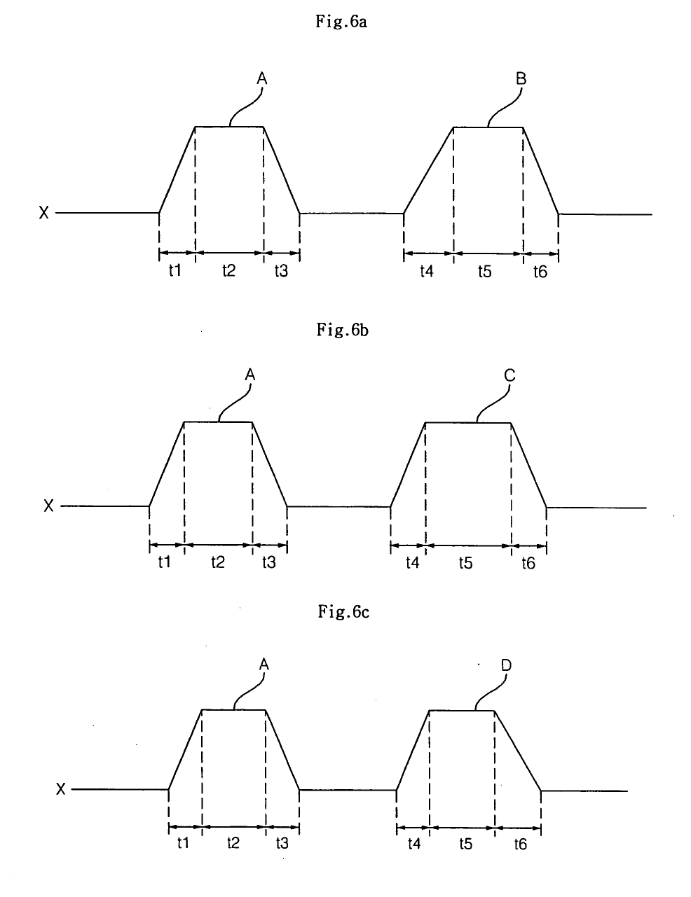

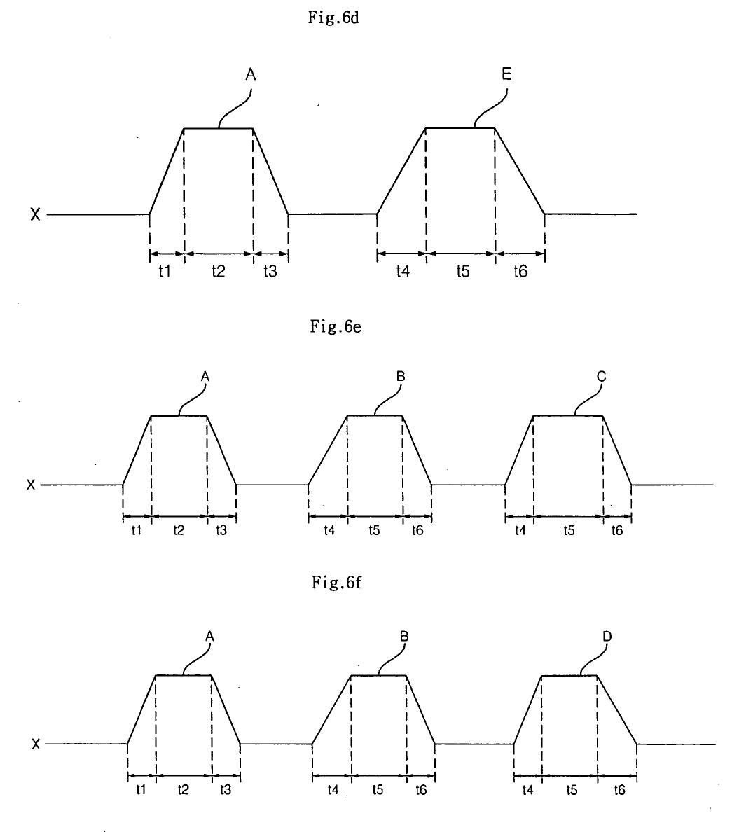

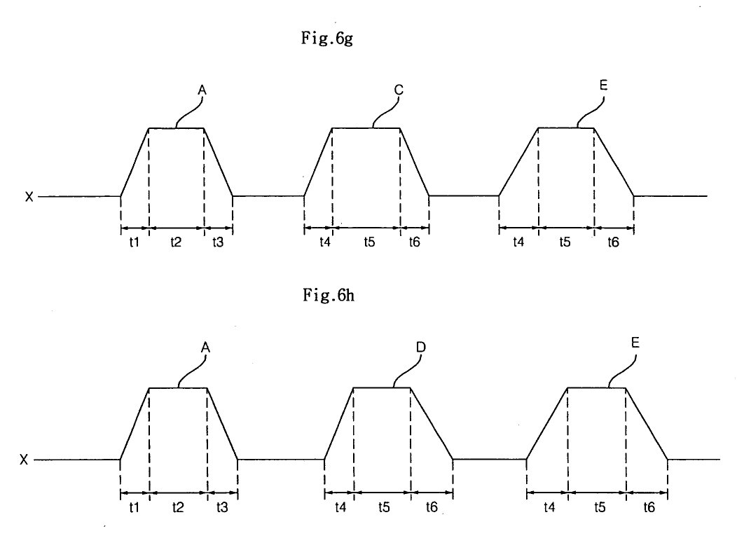

FIG. 6a to FIG. 6h show embodiments of driving signals of a plasma display apparatus according to the present invention.

Referring to FIG. 6a, driving signals applied to the address electrode in one subfield, that is, at least two data signals among a plurality of data signals have a different rising time.

For example, the rising time t1 of a first data signal A and the rising time t4 of a second data signal B which is applied to the address electrode after the first data signal is applied are different.

At this time, in FIG. 6a, the rising time t4 of the second data signal B is set to be longer so that the first data signal and the second data signal are applied to the address electrode X with different widths.

Here, a weak discharge or a misdischarge which can be generated in the second data signal where the application time is late than the first data signal A can be prevented.

At this time, the first data signal A and the sustain period t2, t5, the falling period t3, t6 of the second data signal are substantially identical.

Further, in order to apply data signals to the address electrode with different widths in one subfield, the sustain period of data signal, as shown in FIG. 6b, can be differently set.

That is, it is preferable that the sustain period t2 of the first data signal A and of the sustain period t5 of a third data signal C are different and that the sustain period t2 of the first data signal A is longer than the sustain period t5 of the third data signal C.

Thus, the address discharge of the cell selected in the weak discharge time which can be generated in an application time point of the third data signal can be sufficiently maintained, while the application time point of the third data signal is late than the first data signal A.

At this time, the first data signal A and the rising period t1, t4, the falling period t3, t6 of the third data signal are substantially identical.

On the other hand, as shown in FIG. 6c, the falling period t3 of the first data signal A and the falling period t6 of a fourth data signal D are set to be different. More preferably, the falling period t6 of the fourth data signal D is set to be longer than the falling period t3 of the first data signal A.

At this time, the first data signal A and the rising time t1, t4, the falling time t2, t5 of the fourth data signal are substantially identical. Accordingly, two data signals having different widths can be applied to the address electrode X.

In the meantime, data signals illustrated with FIG. 6a to FIG. 6b only showed that the rising time, the sustain time, and the falling time were different, however, the present invention is not restricted in such case.

For example, as shown in the FIG. 6d, it is preferable that the rising time t1, the falling time t3 of the first data signal A and the rising time t4, the falling time t6 of a fifth data signal E are simultaneously set to be different, while the rising time t4, the falling time t6 of the fifth data signal E are set to be different.

That is, at least one of the rising time, the sustain time, and the falling time of arbitrary two data signals can be differently applied to the address electrode X.

Further, as shown in FIG. 6e to FIG. 6h, the combination of the first data signal A, the second data signal B, and the third data signal C can be applied to the address electrode X in the address period of a subfield.

The combination of the first data signal A, the third data signal C, and the fifth data signal E can be used. That is, a plurality of data signals applied in the address period of a subfield can be applied to the address electrode X with different widths.

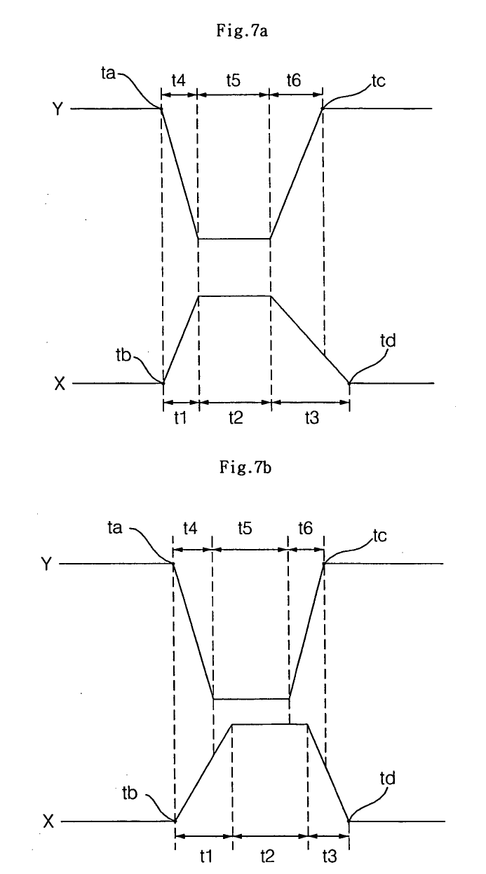

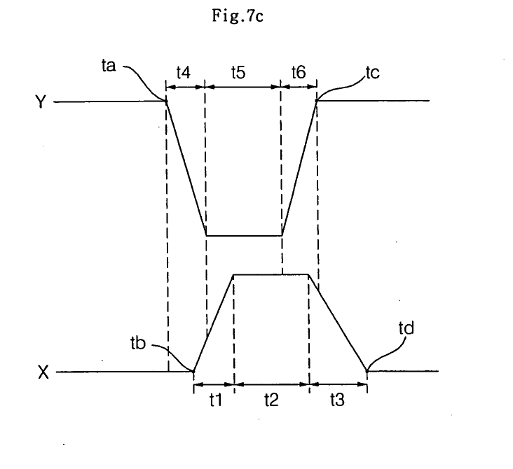

FIG. 7a to FIG. 7c show embodiments of the relationship of a scan signal and a data signal of a plasma display apparatus according to the present invention.

As shown in FIG. 7a, scan signals sequentially applied to scan electrode Y in the address period of one subfield is comprised of falling time t4, sustain time t5, and rising time t6.

It is preferable that the rising time t3 of data signal which is synchronized to the scan signal and the falling time t6 of the scan signal are different, and the rising time t3 of data signal is relatively longer.

In that case, the variation of electric potential is smoothly performed in the falling period of data signal during the period when the address discharge is substantially not generated to reduce the current peak value so that the circuit damage and the wall charge loss of the address electrode X due to a misdischarge can be prevented.

Further, as shown in FIG. 7b, the rising time t1 of the data signal and the rising time t4 of the scan signal can be different. More preferably, the rising time t1 of the data signal is longer than the rising time t4 of the scan signal.

Accordingly, in one subfield, the application time point and the end point of the scan signal, the application time point ta, tb and the end point tc, td of data signal is set to be different.

For example, as shown in FIG. 7a to FIG. 7b, the end-point tc of the scan signal and the end-point td of data signal can be different. As shown in FIG. 7c, not only the end-point of the scan signal and the data signal, but the application time point ta of the scan signal and the application time point tb of the data signal can be different.

At this time, the difference of the application time point ta of the scan signal and the application time point tb of the data signal ranges 10 ns to 300 ns. For a smooth address discharge between the scan electrode Y and the address electrode X, it is preferable that the difference ranges 10 ns to 200 ns.

Further, it is preferable that the difference of the end-point tc of the scan signal and the end-point of the data signal td ranges 10 ns to 200 ns.

In the meantime, the relationship of the scan signal and the data signal of the plasma display apparatus according to the present invention is illustrated with reference to FIG. 7a to FIG. 7c, however, it is not restricted in such case since it is just an embodiment of the present invention.

For example, the rising time, the sustain time, and the falling time of the scan signal can be set up to be longer than the rising time, the sustain time, and the falling time of the data signal. The application time point of the data signal can be prior to the application time point of the scan signal, or the end-point of the data signal can be prior to the end-point of the scan signal.

Further, in arbitrary two subfields among a plurality of subfields, the difference of the application time point and the difference of the end-point of the scan signal and the data signal can be different.

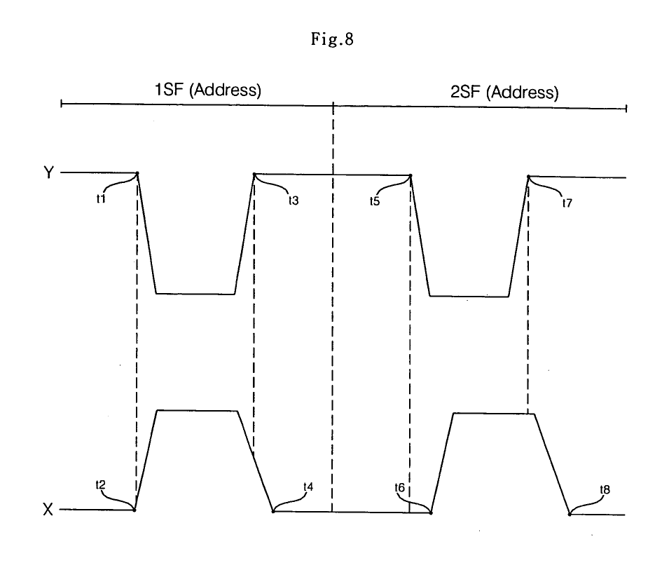

For example, as shown in FIG. 8, the difference of the application time point t1 of the scan signal and the application time point t2 of the data signal in an arbitrary first sub-field 1SF is different from the difference of the application time point t5 of the scan signal and the application time point t6 of the data signal in a second subfield 2SF. Simultaneously, the difference of an end-point can be different.

In this way, in two subfields of a plurality of subfields, the application time point and the end point of the scan signal and the data signal are set to be different. Thus, the widths of the data signals in one subfield are different. Furthermore, the widths of the data signals between subfields are different.

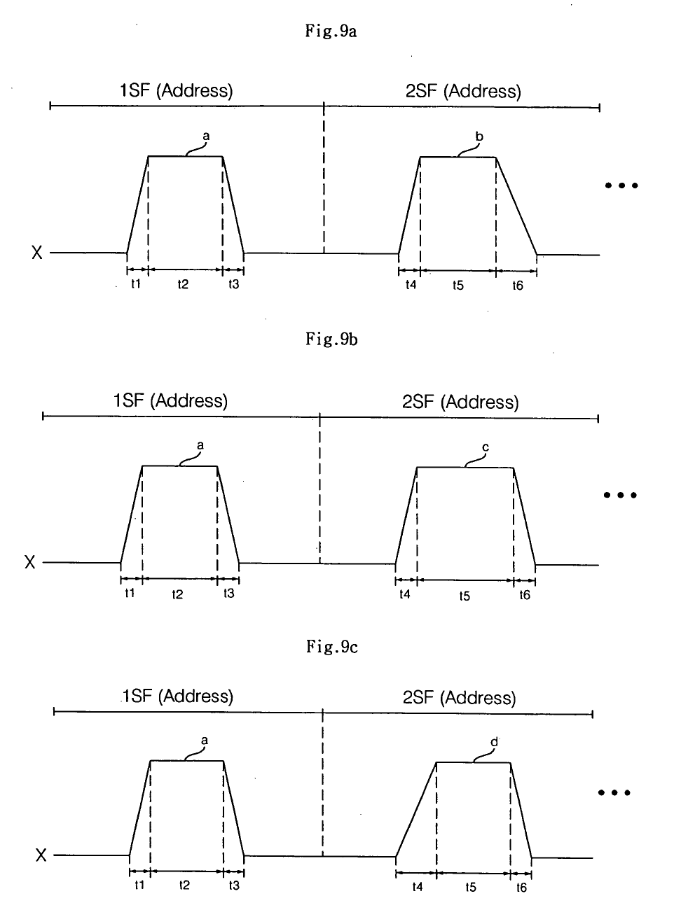

FIG. 9a to FIG. 9c are drawings showing embodiments of data signal of a plasma display apparatus according to the present invention.

Referring to FIG. 9a to FIG. 9c, the data signal a in an arbitrary first sub-field 1SF of a plurality of subfields and the data signal b at a second subfield 2SF in which the point of time is relatively late than the first sub-field 1SF are applied with different widths so that generating a misdischarge is prevented due to a weak discharge in the second subfield 2SF in which the point of time is late.

That is, as shown in FIG. 9a, the falling period t6 of data signal b applied to the address electrode X in the second subfield 2SF is set to be longer than the falling period t3 of data signal a applied to the address electrode X in the first sub-field 1SF to reduce the current peak value so that a misdischarge which can be generated in the next discharge time can be protected.

Further, as shown in FIG. 9b, the data signal c of the second subfield 2SF is set to be longer than the data signal a of the first sub-field 1SF so that the miswriting generated in the weak discharge time can be prevented.

Further, as shown in FIG. 9c, the rising time t4 of the data signal c of the second subfield 2SF is set to be longer than the rising time t4 of the data signal a of the first sub-field 1SF so that a misdischarge generated in the address discharge can be prevented.

In the meantime, in this specification, it was illustrated that each data signal of the first sub-field 1SF and the second subfield 1SF have different rising time, sustain time, and falling time, however, the present invention is not restricted in such case.

That is, at least one of rising time, sustain time, and falling time is set to be different so that the width of data signal can be varied.

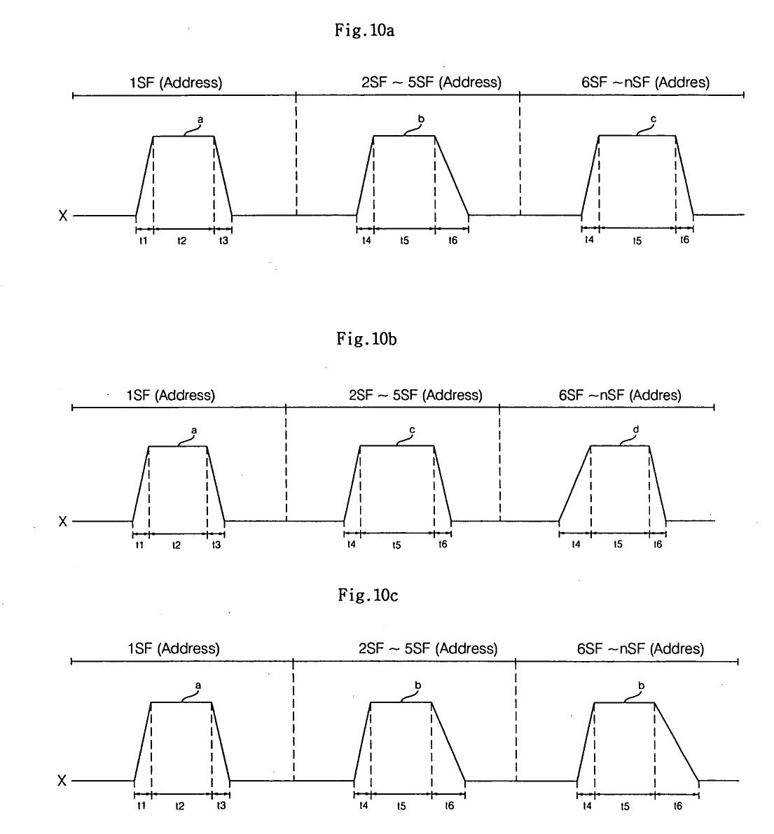

Further, as shown in FIG. 10a to FIG. 10c, data signals having different widths can be applied to a subfield group which is pre-set by the person skilled in the art. Further, in each subfield of a plurality of subfields, data signals can be altogether different.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A plasma display apparatus driven by time dividing an unit frame into a plurality of subfields to display an image, wherein at least two data signals among a plurality of data signals have different widths in one subfield of a plurality of subfields.

2. The apparatus of claim 1, wherein the data signal includes a rising time, a sustain time, and a falling time, while the sum of the rising time, the sustain time, and the falling time form the width of the data signal, wherein the rising time and the falling time respectively ranges from 50 ns to 300 ns.

3. The apparatus of claim 2, wherein the falling time of the data signal is longer than the rising time.

4. The apparatus of claim 2, wherein the sustain time of the data signal ranges from 1 us to 5 us.

5. The apparatus of claim 2, wherein the sustain time of the data signal ranges from 1 us to 3 us.

6. The apparatus of claim 1, wherein, in one subfield of the plurality of subfields, a scan signal which is applied to a plurality of scan electrodes is comprised of a falling time, a sustain time, and a rising time, wherein the rising time of the scan signal is different from the falling time of the data signal corresponding to the scan signal.

7. The apparatus of claim 1, wherein, in one subfield of the plurality of subfields, the rising time of a first data signal is different from the rising time of a second data signal while the application time point of the second data signal is late than the application time point of the first data signal.

8. The apparatus of claim 1, wherein, in one subfield of the plurality of subfields, the sustain time of a first data signal is different from the sustain time of a second data signal while the application time point of the second data signal is late than the application time point of the first data signal.

9. The apparatus of claim 1, wherein, in one subfield of the plurality of subfields, the falling time of a first data signal is different from the falling time of a second data signal while the application time point of the second data signal is late than the application time point of the first data signal.

10. The apparatus of claim 1, wherein, in one subfield of the plurality of subfields, the start time point of a scan signal is different from the start time point of a data signal corresponding to the scan signal.

11. The apparatus of claim 10, wherein the difference between the point of time when the scan signal is applied and the point of time when the data signal is applied ranges from 10 ns to 300 ns.

12. The apparatus of claim 1, wherein, in one subfield of the plurality of subfields, the end-point of a scan signal is different from the end-point of a data signal corresponding to the scan signal.

13. The apparatus of claim 12, wherein the difference between the end-point of the scan signal and the end-point of the data signal ranges 10 ns or 200 ns.

14. A plasma display apparatus driven by time dividing an unit frame into a plurality of subfields to display an image, wherein the width of a data signal in a first subfield is different from the width of a data signal in a second subfield among a plurality of subfields.

15. The apparatus of claim 12, wherein the data signal is comprised of a rising time, a sustain time, and a falling time, while the sum of the rising time, the sustain time, and the falling time form the width of the data signal, wherein the falling time of the data signal is longer than the rising time.

16. The apparatus of claim 14, wherein, in the plurality of subfields, a scan signal applied to a scan electrode in an address period includes a rising time, a sustain time, and a falling time, wherein the rising time of the scan signal is different from the falling time of the data signal corresponding to the scan signal.

17. The apparatus of claim 14, wherein the rising time of the data signal in the first sub-field is different from the rising time of the data signal in the second subfield.

18. The apparatus of claim 14, wherein the sustain time of the data signal in the first sub-field is different from the rising time of the data signal in the second subfield.

19. The apparatus of claim 14, wherein the falling time of the data signal in the first sub-field is different from the falling time of the data signal in the second subfield.

20. The apparatus of claim 14, in any two subfields of the plurality of subfields, wherein the start time point of a scan signal applied to a scan electrode in an address period is different from the start time point of a data signal corresponding to the scan signal.

21. The apparatus of claim 14, in any two subfields of the plurality of subfields, wherein the end-point of a scan signal applied to a scan electrode in an address period is different from the end-point of a data signal corresponding to the scan signal.
